(19) United States
(12) Patent Application Publication
(10) Pub. No.: US 2008/0055148 A1
(43) Pub. Date: Mar. 6, 2008

(54) Electronic device and controlling method thereof

(75) Inventor: Hajime Oosawa, Kokubunji-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/896,200

(22) Filed: Aug. 30, 2007

(30) Foreign Application Priority Data
Sep. 1, 2006 (JP) 2006-237959

(51) Int. Cl. H04L 17/02

(52) U.S. Cl. 341/176

(57) ABSTRACT

According to one embodiment, an electronic device includes a controller which performs communications with a module, executes procedures for initializing the module in response to input of an insertion signal, and stops the communications with the module in response to input of an extraction signal, a power supply which applies a drive voltage to the module in response to input of a power-on command and stops applying the drive voltage to the module in response to input of a power-off command, command supplying section which supplies power-on command to the power supply when the user selects an “on” item and supplies the power-off command to the power supply when the user selects an “off” item, and signal supplying section which supplies the insertion signal to the controller when the user selects the “on” item supplies the extraction signal to the controller when the user selects the “off” item.

### CROSS-REFERENCE TO RELATED APPLICATIONS

This application is based upon and claims the benefit of priority from Japanese Patent Application No. 2006-237959, filed Sep. 1, 2006, the entire contents of which are incorporated herein by reference.

### BACKGROUND

1. Field

One embodiment of the present invention relates to an electronic device comprising a module that has to be initialized. The present invention also relates to a method for controlling the electronic device.

2. Description of the Related Art

Recent portable electronic devices, such as personal computers and PDAs (Personal Digital Assistants), are provided with a card slot into which a card for expanding functions is inserted.

When a card is inserted into a slot, an electronic device detects the insertion and starts initializing the card. After the initialization, the electronic device can use the functions of the card (Jpn. Pat. Appln. KOKAI Publication No. 2006-209744).

Since the development of a module having a desired function is costly, it is thought to provide that function directly for the circuit board of the main body of the existing card having the desired function. Desirably, a portable electronic device should have a function of stopping the supply of a drive current to those modules which are not used then.

If the function is incorporated in the circuit board, the card does not have to be inserted into the slot. This means that the module is not initialized and cannot be put to use.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an example of an outward appearance of an electronic device according to one embodiment of the present invention.

FIG. 2 is an exemplary block diagram illustrating the system configuration of the electronic device shown in FIG. 1.

FIG. 3 is an exemplary block diagram illustrating an application program and an I/O controller driver, which are included in the electronic device shown in FIG. 1.

FIG. 4 shows an example of an operation menu used by the electronic device shown in FIG. 1.

FIG. 5 is an exemplary flowchart illustrating how the electronic device shown in FIG. 1 controls the supply of a drive current to a wireless LAN module.

### DETAILED DESCRIPTION

Various embodiments according to the invention will be described hereinafter with reference to the accompanying drawings. In general, according to one embodiment of the invention, an electronic device comprises a body, a module provided inside the body and having a predetermined function, a controller which performs communications with the module, executes procedures for initializing the module in response to input of an insertion signal, and stops the communications with the module in response to input of an extraction signal, a power supply which applies a drive voltage to the module in response to input of a power-on command and stops applying the drive voltage to the module in response to input of a power-off command, a display which displays an “on” item and an “off” item, operation button which permits a user to select one of the “on” item and “off” item, command supplying section which supplies power-on command to the power supply when the user selects the “on” item and supplies the power-off command to the power supply when the user selects the “off” item, and signal supplying section which supplies the insertion signal to the controller when the user selects the “on” item and supplies the extraction signal to the controller when the user selects the “off” item.

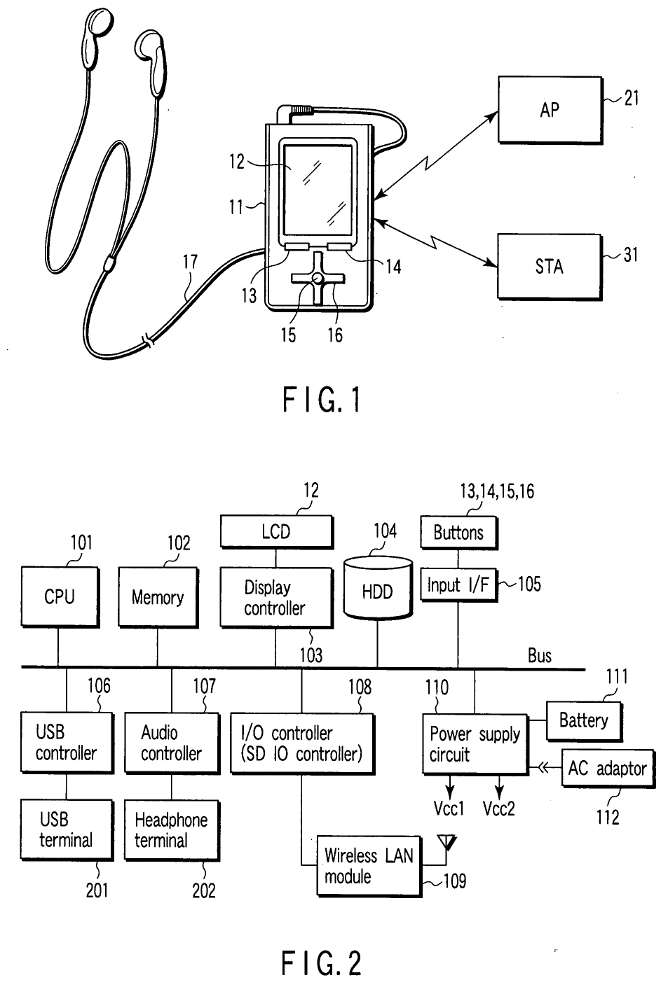

An electronic device according to one embodiment of the present invention will now be described with reference to FIG. 1.

The subject electronic device is a portable device which is embodied, for example, as a personal computer, a PDA, an AV (audio-video) player, and which can be driven by a built-in battery. In the following description, reference will be made to the case where the electronic device is an AV player 11 used for reproducing audio data and video data.

An LCD 12 (which is used as a display device) and various operation buttons (which function as an input device and include a back button 13, a start button 14, an OK button 15 and a plus button 16) are provided on the main body of the AV player 11. A headphone 17 is connected to a headphone terminal provided, for example, on the upper surface of the main body of the AV player 11.

The AV player 11 has a wireless communication function, such as the wireless LAN defined by the IEEE802.11b/g standard. By use of this function, the AV player 11 can perform wireless communications with various types of radio devices compatible with the IEEE802.11b/g standard, such as an access point (AP) 21 and a station (STA) 31. For example, when the AV player 11 is in wireless connection to the access point 21, it can access a server on the Internet by way of the access point (AP) 21 and downloads audio data, video data and other kinds of data from the server. The station 31 is a personal computer or another AV player having the same wireless communication function as the AV player 11 mentioned above. When the AV player 11 is in wireless connection to the station (STA) 31, it can exchange audio data, video data and other kinds of data with the station (STA) 31.

The system configuration of the AV player 11 will be described with reference to FIG. 2.

As shown in FIG. 2, the AV player 11 is provided with a CPU 101, a memory 102, a display controller 103, a hard disk drive (HDD) 104, an input interface section 105, a USB controller 106, an audio controller 107, an I/O controller 108, a wireless LAN module 109, a power supply circuit 110, a battery 111, etc.

The CPU 101 is a processor that controls the operation of the AV player 11. It executes various kinds of programs loaded in the memory 102, including an operating system, an application program, a wireless LAN driver, etc. The application program is used for reproducing audio data and video data and for executing wireless communications. The wireless LAN driver is a driver program used for controlling the wireless LAN module 109 in response to a request made by the application program.

The display controller 103 controls the LCD 12 so that images corresponding to operation menus and video data reproduced by the application program are shown on the display screen of the LCD 12. The HDD 104 functions as a storage device used for storing audio data, video data and other kinds of data. The USB controller 106 is connected to a USB terminal 201 provided on the main body of the AV player 11. The USB controller 106 executes communications with devices connected to the USB terminal 201. The audio controller 107 is a sound generating device. This device generates sound signals corresponding to the audio data reproduced by the application program and supplies the sound signals to the headphone terminal 202 for output. The I/O controller 108 is a controller serving as an interface with the wireless LAN module 109. The I/O controller 108 is, for example, an SD IO host controller used for controlling an SD IO card. In this case, the I/O controller 108 is connected to the LAN module 109 by means of an SD IO bus, and communications based on the SDIO standard are executed. The wireless LAN module 109 is mounted on the circuit board of the main body and is not detachable.

The wireless LAN module 109 is a wireless communication module that executes wireless communications based on the IEEE802.11b/g standard. The wireless LAN module 109 is a type that can be sealed within an SD card. In the IEEE802.11b/g standard, thirteen wireless communication channels (namely, channels 1 to 13) having different carrier frequencies are defined. The wireless LAN module 109 uses one of the thirteen wireless communication channels when it performs wireless communications.

The power supply circuit 110 uses either the power provided by the battery 111 inside the main body of the AV player 11 or the power provided by an external AC adaptor 112, and supplies an operating current to each of the components.

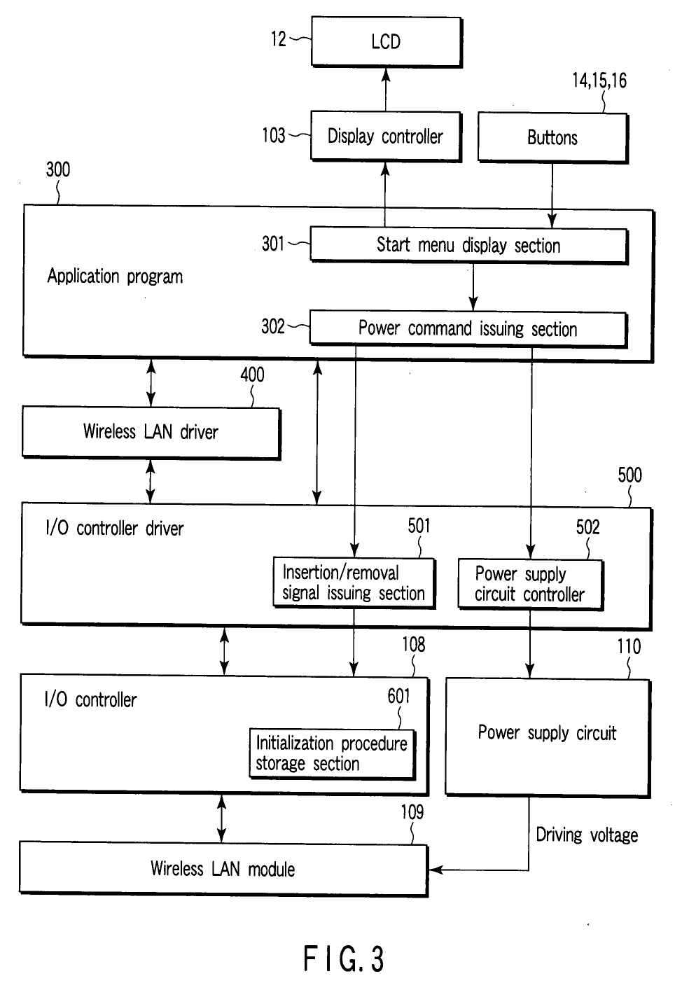

A description will be given, with reference to FIG. 3, of the function of controlling the application of drive power to the wireless LAN module 109. FIG. 3 illustrates the relationships among the LCD 12, the display controller 103, the start button 14, the OK button 15, the plus button 16, the application program 300, the wireless LAN driver 400, an I/O controller driver 500, the I/O controller 108, the wireless LAN module 109 and the power supply circuit 110.

In the following, the functions and configurations of the application program 300, wireless LAN driver 400, I/O controller driver 500 and I/O controller 10 will be described.

The application program 300 is a program used for transferring various kinds of contents data (audio data, video data, etc.) to radio devices wirelessly. The application program 300 receives an operation request the user makes regarding the radio communication functions by using a GUI. In response to the operation request, the wireless LAN driver 400 executes communications with reference to the wireless LAN driver 400. The application program 300 is provided with a start menu display section 301 and a power command issuing section 302. The start menu display section 301 and the power command issuing section 302 are software modules which the CPU 101 executes.

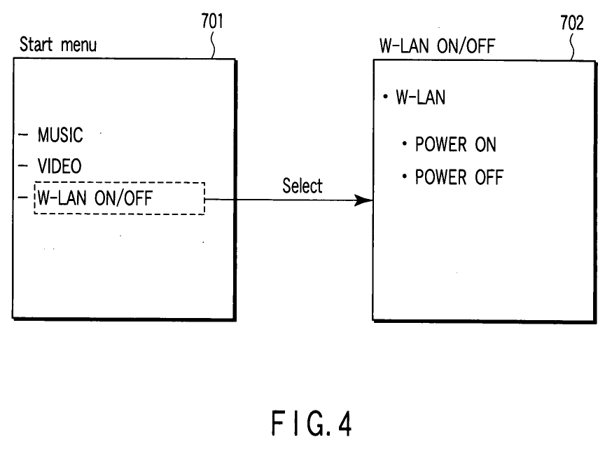

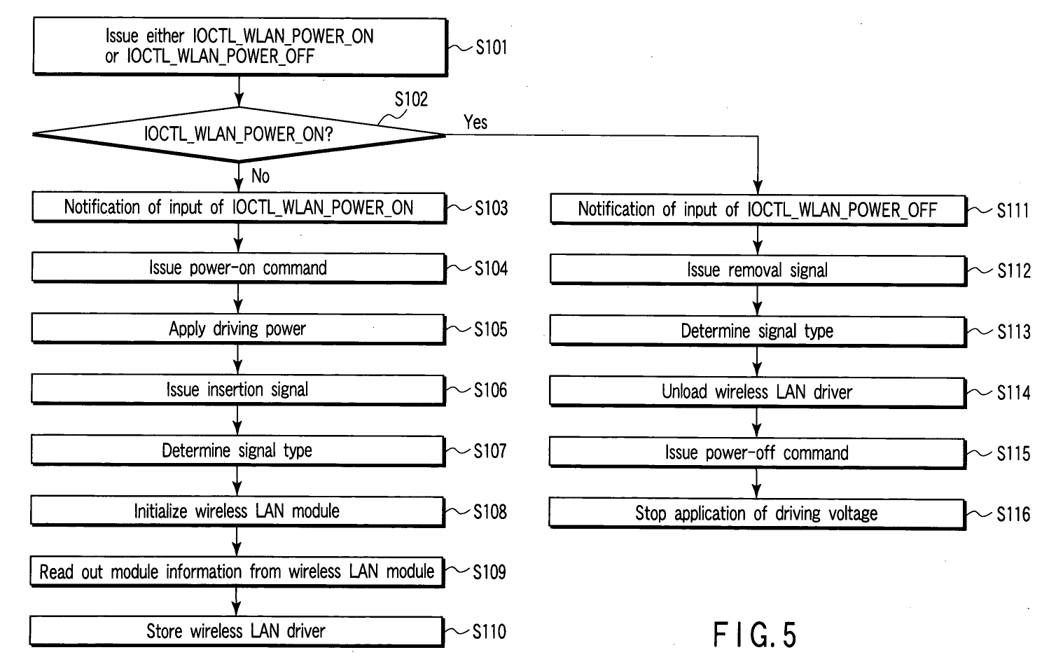

When the user depresses the start button 14, the start menu display section 301 controls the LCD 12 to show a start menu, such as that shown in FIG. 4. The start menu 701 permits the user to select a function the user would like to execute. Three function items, such as “MUSIC”, “VIDEO” ABD “W-LAN ON/OFF”, are shown on the start menu 701. The start menu display section 301 scrolls the selection items shown on the LCD 12 in response to the user's operation of depressing the upper side or lower side of the plus button 16. When the user depresses the OK button 15, the start menu display section 301 detects the determined (okayed) selection item and notifies the corresponding module of the detection.

Let us assume that the user selects “MUSIC.” In this case, the application program 300 controls the LCD 12 to display a list of the audio data stored in the HDD 104. Then, the application program 300 reproduces the audio data which the user has selected from the list of the audio data. When the user selects “VIDEO”, the application program 300 controls the LCD 12 to display a list of the video data stored in the HDD 104. Then, the application program 300 reproduces the video data which the user has selected from the list of the video data.

When the user selects “W-LAN ON/OFF”, the start menu display section 301 controls the LCD 12 to display a menu 702 that permits the user to determine whether or not a drive voltage should be applied to the wireless LAN module 109. When the user makes selection/determination by operating the plus button 16 and OK button 15, the start menu display section 301 detects an item the user has selected and notifies the power command issuing section 302 of the result of detection. In accordance with the item, the power command issuing section 302 issues either IOCTL_WLAN_POWER_ON or IOCTL_WLAN_POWER_OFF and supplies it to the I/O controller driver 500.

The wireless LAN driver 400 is a program used for controlling the wireless LAN module 109 in response to a request made by the application program 300.

The I/O controller driver 500 is a program used for controlling the I/O controller 108 in response to a request made by the application program 300 or the wireless LAN driver 400. The I/O controller driver 500 includes an insertion/removal signal issuing section 501 and a power supply circuit controller 502. The insertion/removal signal issuing section 501 and the power supply circuit controller 502 are software modules which the CPU 101 executes.

The insertion/removal signal issuing section 501 issues either an insertion signal or a removal signal in accordance with the notification made by the power command issuing section 302, and supplies the issued signal to the I/O controller 108. Upon receipt of the insertion signal, the I/O controller 108 initializes the wireless LAN module on the basis of the procedures whose data is stored in an initialization procedure storage section 601. Upon receipt of the removal signal, the I/O controller 108 ends the communications with the wireless LAN module 109, and switches the mode to a standby mode so as to reduce the power consumption.

In accordance with the notification by the power command issuing section 302, the power supply circuit controller 502 issues either a power-on command or a power-off command, and supplies the issued command to the power supply circuit 110. Upon receipt of the power-on command, the power supply circuit 110 applies a drive voltage to the wireless LAN module 109. Upon receipt of the power-off command, the power supply circuit 110 stops the application of the drive voltage to the wireless LAN module 109.

The procedures for controlling the application of drive voltage to the wireless LAN module 109 will be described with reference to the flowchart shown in FIG. 6. In the following description, the case where the user selects the power-on state and the case where the user selects the power-off state will be described separately.

First, reference will be made to the case where the user selects the power-on state. When the user selects or determines the power-on state, the power command issuing section 302 issues IOCTL_WLAN_POWER_ON and supplies it to the I/O controller driver 500 (Step S101).

The I/O controller driver 500 determines whether or not the input command is IOCTL_WLAN_POWER_ON (Step S102). If the input command is determined as IOCTL_WLAN_POWER_ON (“YES” in Step S102), the I/O controller driver 500 notifies the insertion/removal signal issuing section 501 and power supply circuit controller 502 of the input of IOCTL_WLAN_POWER_ON (Step S103).

The power supply circuit controller 502 issues a power-on command and supplies it to the power supply circuit 110 (Step S104). In accordance with the power-on command, the power supply circuit 110 applies power to the wireless LAN module 109 (Step S105). The insertion/removal signal issuing section 501 transmits a pseudo insertion signal to the I/O controller 108 (Step S106).

The I/O controller 108 determines whether or not the interrupt signal is an insertion signal (Step S107). Since the interrupt signal is an insertion signal in this case, the I/O controller 108 determines that the insertion signal has been input. Then, the I/O controller 108 initializes the wireless LAN module 109 on the basis of the sequence stored in the initialization procedure storage section 601 (Step S108).

When the initialization procedures have been completed, the I/O controller 108 reads out module information from the wireless LAN module 109 (Step S109). On the basis of the readout information, the module loads the wireless LAN driver 400 and stores it in the RAM of the controller 108 (Step S110). On the basis of the wireless LAN driver 400 stored in the RAM, the I/O controller 108 performs communications with the wireless LAN module 109.

When the user selects the power-on state of the wireless LAN module 109, the wireless LAN module 109 is applied with a drive voltage and is simultaneously initialized.

A description will now be given of the case where the user selects the power-off state. When the user selects or determines the power-off state, the power command issuing section 302 issues IOCTL_WLAN_POWER_OFF and supplies it to the I/O controller driver 500 (Step S101).

The I/O controller driver 500 determines whether or not the input command is IOCTL_WLAN_POWER_ON (Step S102). Since IOCTL_WLAN_POWER_OFF has been input in this case, the I/O controller driver 500 determines that IOCTL_WLAN_POWER_ON is not input (“NO” in Step S102). Then, the I/O controller driver 500 notifies the insertion/removal signal issuing section 501 and power supply circuit controller 502 of the input of IOCTL_WLAN_POWER_OFF (Step S111).

The insertion/removal signal issuing section 501 transmits a pseudo removal signal to the I/O controller 108 (Step S112). The I/O controller 108 determines whether or not the input signal is an insertion signal (Step S113). Since the input signal is a removal signal in this case, the I/O controller 108 determines that the insertion signal has not been input. In this case, the I/O controller 108 first stops the communications with the wireless LAN module 109 and then deletes the driver from the RAM (Step S114). Thereafter, the I/O controller 108 switches the mode to a standby mode so as to reduce the power consumption.

The power supply circuit controller 502 issues a power-off command and supplies it to the power supply circuit 110 (Step S115). In response to the power-off command, the power supply circuit 110 stops the application of the drive voltage to the wireless LAN module 109 (Step S116).

The processing described above can stop the application of drive power to the wireless LAN module 109. In the electronic device described above, the wireless LAN module 109, which realizes the wireless LAN function, is mounted on the circuit board. A module for realizing the GPS function or another function may be mounted on the circuit board.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device comprising:
a body;
a module provided inside the body and having a predetermined function;
a controller which performs communications with the module, executes procedures for initializing the module in response to input of an insertion signal, and stops the communications with the module in response to input of an extraction signal;
a power supply which applies a drive voltage to the module in response to input of a power-on command and stops applying the drive voltage to the module in response to input of a power-off command;
a display which displays an “on” item and an “off” item;
operation button which permits a user to select one of the “on” item and “off” item;
command supplying section which supplies power-on command to the power supply when the user selects the “on” item and supplies the power-off command to the power supply when the user selects the “off” item; and
signal supplying section which supplies the insertion signal to the controller when the user selects the “on” item and supplies the extraction signal to the controller when the user selects the “off” item.

2. The electronic device according to claim 1, wherein the module and the controller communicate with each other based on a standard used for communications with an expansion card.

3. The electronic device according to claim 2, wherein the standard used for communications with the expansion card is an SDIO standard.

4. The electronic device according to claim 1, wherein the module has a function of performing wireless communications.

5. The electronic device according to claim 1, wherein the module is mounted on a circuit board.

6. An electronic device-controlling method, comprising:
controlling a display to display an “on” item and an “off” item;
detecting an item which a user selects;
supplying a power-on command to a power supply in a case where the detected item is the “on” item, the power supply being configured to applying a drive voltage to a module having a predetermined function;
applying drive voltage to the module from the power supply in response to input of the power-on command;
supplying an insertion signal to a controller after applying the drive voltage, the controller being configured to perform communications with the module;
executing procedures by which the controller initializes the module, in response to input of the insertion signal;
supplying a extraction signal to the controller in a case where the detected item is not the “on” item;
stopping the communications with the controller and the module, in response to input of the extraction signal;
supplying a power-off command to the power supply after stopping the communications; and
stopping supplying the drive voltage to the module in response to input of the power-off command.

7. The electronic device-controlling method according to claim 6, wherein the module and the controller communicate with each other based on a standard used for communications with an expansion card.

8. The electronic device-controlling method according to claim 7, wherein the standard used for communications with the expansion card is an SDIO standard.

9. The electronic device-controlling method according to claim 6, wherein the module has a function of performing wireless communications.

10. The electronic device-controlling method according to claim 6, wherein the module is mounted on a circuit board.
